(19) United States
(12) Patent Application Publication
(10) Pub. No.: US 2026/0339939 A1
(43) Pub. Date: Oct. 29, 2026

(54) METHOD AND SYSTEM FOR EXECUTING QUESTION AND ANSWER TASK ON KNOWLEDGE GRAPH USING LARGE LANGUAGE MODEL

(71) Applicant: JPMorgan Chase Bank, N.A., New York, NY (US)

(72) Inventors: Ajay VERMA, Bangalore (IN); Richa MALIK, Bengaluru (IN); Abhishek MITRA, Bangalore (IN); Simant KUMAR, Bengaluru (IN)

(73) Assignee: JPMorgan Chase Bank, N.A., New York, NY (US)

(21) Appl. No.: 19/233,698

(22) Filed: Jun. 10, 2025

(30) Foreign Application Priority Data
Apr. 28, 2025 (IN) 202511040894

(51) Int. Cl. G06F 16/2452; G06F 16/22; G06N 3/042

(52) U.S. Cl. CPC G06F 16/24522; G06F 16/2237; G06N 3/042

(57) ABSTRACT

A method and system for executing question-and-answer tasks on a knowledge graph (KG) using a large language model (LLM) are disclosed. The method includes receiving a user query indicating an information request related to entities within the KG, the user query comprising intent and topic. The method further includes parsing the user query into sub-queries, each sub-query corresponding to a distinct component of the information request. The method further includes generating vector embeddings for the sub-queries. The method further includes performing a similarity search in a vector database to retrieve nodes and corresponding relationships that match the vector embeddings of the sub-queries. The method further includes executing a graph query using node identifiers and relationship identifiers to obtain context data from the KG. Thereafter, the method includes generating, using the LLM, a response to the user query.

### CROSS-REFERENCE TO RELATED APPLICATIONS

This application claims priority benefit from Indian Application No. 202511040894, filed Apr. 28, 2025 in the Indian Patent Office, which is hereby incorporated by reference in its entirety.

### FIELD OF THE DISCLOSURE

This technology generally relates to a large language model (LLM), and more particularly relates to a method and system for executing a question-and-answer task on a knowledge graph (KG) using a large language model (LLM).

### BACKGROUND INFORMATION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

In recent years, knowledge graphs (KGs) have become crucial tools for organizing and retrieving structured information across various domains, such as healthcare, finance, e-commerce, and artificial intelligence. A KG is a structured representation of entities, relationships, and attributes that provides a connected view of complex information. By capturing relationships between entities, KGs allow users to explore interconnected information and derive insights from the structure of the graph. This makes KGs particularly valuable for applications requiring contextual understanding, such as recommendation systems, search engines, data integration, and question-and-answer (Q&A) tasks.

Large language models (LLMs) have revolutionized natural language processing (NLP) by excelling in understanding, generating, and interacting with human language. These models, trained on massive corpora of unstructured text, are highly capable of generating coherent responses to diverse queries. LLMs use embeddings derived from language data to capture semantic meanings, enabling them to process queries and produce contextually relevant answers. While LLMs are proficient with unstructured or semi-structured text, these face challenges when working with structured data like KGs, as KGs represent information in a format that is inherently different from the format processed by LLMs.

Integrating LLMs with KGs could significantly enhance information retrieval by combining the contextual depth of LLMs with the structured, fact-based accuracy of the KG. However, merging these technologies presents several challenges. First, there is a fundamental difference in how each technology represents information. KGs often rely on graph neural networks (GNNs) to create embeddings based on graph structure, while LLMs use embeddings derived from unstructured text. This difference can lead to semantic misalignment, where KG data may not integrate seamlessly with the language-based embeddings used by LLMs, resulting in suboptimal retrieval of information and limited context for the LLM to generate accurate answers.

Another major challenge involves constructing accurate queries to extract data from a KG. One approach is to transform a user's natural language request into a Cypher query (or another graph database query language, such as SPARQL or Gremlin). However, this requires a high level of expertise in query languages and knowledge of the KG schema, which makes it difficult for most users to interact directly with the KGs. Additionally, the LLM itself would need to generate syntactically correct and schema-compliant queries, which can be challenging, given the complexity of KGs and the variability in user queries. Furthermore, if the KG schema changes over time, the query generation process must be adjusted to account for new entity types and relationships, making this approach labor-intensive and inflexible.

An alternative approach to the problem is to flatten the KG into a text-based format, such as JSON, which the LLM can interpret more easily. This method enables the LLM to perform similarity searches on the flattened data using language embeddings. However, flattening leads to significant limitations, including redundancy, increased storage costs, and synchronization challenges. Flattened data lacks the rich, interconnected structure of a KG, leading to a loss of fine-grained relationships and context. Moreover, once KG data is flattened, it cannot be easily converted back into a graph format, restricting the system's ability to perform advanced tasks, such as node similarity analysis or graph traversal, which are essential for certain types of queries.

Current methods for integrating KGs with LLMs, such as query-based retrieval or flattened semantic search, have significant drawbacks. Query-based retrieval, while being precise, is often inaccessible to non-technical users and is highly dependent on a stable KG schema. Flattened semantic search, although simpler, fails to capture the complex relational structure of the KG, leading to incomplete or inaccurate information retrieval. Consequently, these methods result in inconsistent user experience and limited accuracy in responses to complex, multi-faceted queries.

Hence, in view of these and other existing limitations, there arises an imperative need to provide an efficient solution to overcome the above-mentioned limitations and to provide a method and system for executing a question-and-answer task on a KG using an LLM.

### SUMMARY

The present disclosure, through one or more of its various aspects, embodiments, and/or specific features or sub-components, provides inter alias, various systems, servers, devices, methods, media, programs, and platforms for executing a question-and-answer task on a KG using an LLM.

According to an aspect of the present disclosure, a method for executing a question-and-answer task on a KG using an LLM is disclosed. The method is implemented by at least one processor. The method may include receiving, by the at least one processor, a user query indicating an information request related to a set of entities within the KG, the user query comprising at least one intent and at least one topic. The method may further include parsing, by the at least one processor, the user query into a set of sub-queries, each sub-query corresponding to a distinct component of the information request. Each sub-query is associated with the at least one intent and the at least one topic. The method may further include generating, by the at least one processor, a set of vector embeddings for the set of sub-queries. Each respective vector embedding corresponds to at least one respective sub-query. The method may further include performing, by the at least one processor, a similarity search in a vector database to retrieve a set of nodes and a corresponding set of relationships that matches the set of vector embeddings of the set of sub-queries. The similarity search facilitates in identifying node identifiers (IDs) and relationship IDs corresponding to the information request. The method may further include executing, by the at least one processor, a graph query using the node IDs and relationship IDs to obtain context data from the KG. Thereafter, the method may include generating, by the at least one processor using the LLM, a response to the user query, wherein the response is based on the user query, the set of sub-queries, the context data retrieved from the KG, and KG schema.

In accordance with another exemplary embodiment, the method may further include inputting, by the at least one processor, the context data and the user query into the LLM to generate the response to the user query.

In accordance with another exemplary embodiment, the method may further include converting, by the at least one processor, node-edge-node relationships in the KG into a set of text-based representations, wherein each respective text-based representation describes a respective relationship between two respective nodes in the KG, and transforming the set of text-based representations into the set of vector embeddings; and storing, by the at least one processor, the set of vector embeddings in the vector database, each respective vector embedding being indexed according to a combination of a corresponding node ID and a corresponding relationship ID, and with each respective relationship having a corresponding relationship type that is stored in a separate respective index within the vector database.

In accordance with another exemplary embodiment, the method may further comprise rendering, by the at least one processor using a display, the response generated by the LLM, wherein the response comprises the set of entities and the corresponding set of relationships in the KG that satisfy the information request.

In accordance with another exemplary embodiment, the storing of the set of vector embeddings in the vector database may comprise creating a separate respective index for each respective type of relationship in the KG.

In accordance with another exemplary embodiment, the at least one intent of each sub-query may indicate whether the sub-query specifies an inclusion criterion to include the set of entities based on a specific condition, or an exclusion criterion to omit the set of entities based on the specific condition.

In accordance with another exemplary embodiment, the parsing of the user query may comprise mapping each respective intent to a corresponding relationship type within the KG; and mapping each respective topic to a corresponding node type within the KG.

According to another aspect of the present disclosure, a computing device configured to implement an execution of a method for executing a question-and-answer task on a KG using an LLM is disclosed. The computing device includes at least one processor; a memory; and a communication interface coupled to each of the at least one processor and the memory. The at least one processor may be configured to receive a user query indicating an information request related to a set of entities within the KG, the user query comprising at least one intent and at least one topic. The processor may be further configured to parse the user query into a set of sub-queries, each sub-query corresponding to a distinct component of the information request. Each sub-query is associated with the at least one intent and the at least one topic. The processor may be further configured to generate a set of vector embeddings for the set of sub-queries. Each respective vector embedding corresponds to at least one respective sub-query. The processor may be further configured to perform a similarity search in a vector database to retrieve a set of nodes and a corresponding set of relationships that matches the set of vector embeddings of the set of sub-queries. The similarity search facilitates in identifying node identifiers (IDs) and relationship IDs corresponding to the information request. The processor may be further configured to execute a graph query using the node IDs and relationship IDs to obtain context data from the KG, Thereafter, the processor may be further configured to generate, using the LLM, a response to the user query. The response is based on the user query, the set of sub-queries, the context data retrieved from the KG, and KG schema.

In accordance with another exemplary embodiment, the at least one processor may be further configured to input the context data and the user query into the LLM to generate the response to the user query.

In accordance with another exemplary embodiment, the at least one processor may be further configured to convert node-edge-node relationships in the KG into a set of text-based representations, wherein each respective text-based representation describes a respective relationship between two respective nodes in the KG, and to transform the set of text-based representations into the set of vector embeddings; and to store the set of vector embeddings in the vector database, each respective vector embedding being indexed according to a combination of a corresponding node ID and a corresponding relationship ID, and with each respective relationship having a corresponding relationship type that is stored in a separate respective index within the vector database.

In accordance with another exemplary embodiment, the at least one processor may be further configured to render, using a display, the response generated by the LLM, wherein the response comprises the set of entities and the corresponding set of relationships in the KG that satisfy the information request.

In accordance with another exemplary embodiment, the storing of the set of vector embeddings in the vector database may comprise creating a separate respective index for each respective type of relationship in the KG.

In accordance with another exemplary embodiment, the at least one intent of each sub-query may indicate whether the sub-query specifies an inclusion criterion to include the set of entities based on a specific condition, or an exclusion criterion to omit the set of entities based on the specific condition.

In accordance with another exemplary embodiment, for the parsing of the user query, the at least one processor may be further configured to map each respective intent to a corresponding relationship type within the KG; and to map each respective topic to a corresponding node type within the KG.

According to yet another aspect of the present disclosure, a non-transitory computer-readable storage medium storing instructions to execute a question-and-answer task on a knowledge graph (KG) using a large language model (LLM) is disclosed. The instructions include executable code which, when executed by a processor, may cause the processor to perform operations which include the following: receive a user query indicating an information request related to a set of entities within the KG, the user query comprising at least one intent and at least one topic; parse the user query into a set of sub-queries, each sub-query corresponding to a distinct component of the information request, wherein each sub-query is associated with the at least one intent and the at least one topic; generate a set of vector embeddings for the set of sub-queries, wherein each respective vector embedding corresponds to at least one respective sub-query; perform a similarity search in a vector database to retrieve a set of nodes and a corresponding set of relationships that matches the set of vector embeddings of the set of sub-queries, wherein the similarity search facilitates in identifying node IDs and relationship IDs corresponding to the information request; execute a graph query using the node IDs and relationship IDs to obtain context data from the KG; and generate, using the LLM, a response to the user query, wherein the response is based on the user query, the set of sub-queries, the context data retrieved from the KG, and KG schema.

In accordance with another exemplary embodiment, the executable code when executed may further cause the processor to input the context data and the user query into the LLM to generate the response to the user query.

In accordance with another exemplary embodiment, the executable code when executed may further cause the processor to convert node-edge-node relationships in the KG into a set of text-based representations, wherein each respective text-based representation describes a respective relationship between two respective nodes in the KG, and to transform the set of text-based representations into the set of vector embeddings; and to store the set of vector embeddings in the vector database, each respective vector embedding being indexed according to a combination of a corresponding node ID and a corresponding relationship ID, and with each respective relationship having a corresponding relationship type that is stored in a separate respective index within the vector database.

In accordance with another exemplary embodiment, the executable code when executed may further cause the processor to render, using a display, the response generated by the LLM, wherein the response comprises the set of entities and corresponding set of relationships in the KG that satisfy the information request.

In accordance with another exemplary embodiment, the storing of the set of vector embeddings in the vector database may comprise creating a separate respective index for each respective type of relationship in the KG.

In accordance with another exemplary embodiment, the at least one intent of each sub-query may indicate whether the sub-query specifies an inclusion criterion to include the set of entities based on a specific condition, or an exclusion criterion to omit the set of entities based on the specific condition.

In accordance with another exemplary embodiment, to parse the user query, the executable code when executed may further cause the processor to map each respective intent to a corresponding relationship type within the KG; and to map each respective topic to a corresponding node type within the KG.

### BRIEF DESCRIPTION OF THE DRAWINGS

The present disclosure is further described in the detailed description which follows, about the noted plurality of drawings, by way of non-limiting examples of exemplary embodiments of the present disclosure, in which characters represent like elements throughout the several views of the drawings.

FIG. 1 illustrates an exemplary computer system for executing a question-and-answer task on a KG using an LLM, in accordance with an exemplary embodiment of the present disclosure.

FIG. 2 illustrates an exemplary diagram of a network environment for executing a question-and-answer task on a KG using an LLM, in accordance with an exemplary embodiment of the present disclosure.

FIG. 3 illustrates an exemplary system for executing a question-and-answer task on a KG using an LLM, in accordance with an exemplary embodiment of the present disclosure.

FIG. 4 illustrates an exemplary method flow diagram for executing a question-and-answer task on a KG using an LLM, in accordance with an exemplary embodiment of the present disclosure.

FIG. 5 illustrates a process flow of a system for executing a question-and-answer task on a KG using an LLM, in accordance with an embodiment of the present disclosure.

FIG. 6 illustrates an exemplary flow diagram for executing a question-and-answer task on a KG using an LLM, in accordance with an exemplary embodiment of the present disclosure.

### DETAILED DESCRIPTION

Exemplary embodiments now will be described with reference to the accompanying drawings. The invention may, however, be embodied in many different forms and should not be construed as limited to the embodiments set forth herein; rather, these embodiments are provided so that the present disclosure will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items. Also, as used herein, the phrase “at least one” means and includes “one or more” and such phrases or terms can be used interchangeably.

Unless otherwise defined, all terms (including technical and scientific terms) used herein have the same meaning as commonly understood by one of the ordinary skills in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections and the actual physical connections may be different.

In addition, all logical units and/or controllers described and depicted in the figures include the software and/or hardware components required for the unit to function. Further, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the disclosure. It will be apparent, however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable medium having instructions stored thereon for one or more aspects of the present technology as described and illustrated by way of the examples herein. The instructions in some examples include executable code that, when executed by one or more processors, causes the processors to carry out steps necessary to implement the methods of the examples of this technology that are described and illustrated herein.

Currently, there is a significant need for systems that enable effective and integrated question-and-answer (Q&A) processing on knowledge graphs (KGs) using large language models (LLMs). While existing solutions offer either direct graph query capabilities or basic text-based semantic search, these are insufficient for handling complex, multi-faceted user queries in a dynamic KG environment. The existing solutions typically fall into two limited approaches: transforming user requests into complex graph queries and flattening KG data for compatibility with LLMs. These methods struggle with multi-dimensional queries, leading to inefficiencies such as data duplication, loss of relational context, and high maintenance due to schema dependencies. Additionally, they lack real-time adaptability, automatic query decomposition, and vector-based similarity search, which are essential for dynamic and context-rich information retrieval. Present technologies may fail to bridge the semantic gap between KG and LLM embeddings, making accurate and efficient retrieval challenging. This results in a dependency on manual coding and frequent updates to handle schema changes, limiting scalability and usability. The present invention addresses these gaps by providing a solution that enables adaptive query decomposition, embedding generation, and similarity-based retrieval, thereby allowing KGs to deliver contextually accurate responses using LLMs.

The present disclosure solves the aforementioned problems by providing a method and system for executing question and answer tasks on a KG using an LLM. In the present disclosure, initially, the system converts node-edge-node relationships within the KG into text-based representations, wherein each representation describes a relationship between two nodes according to the graph schema. The system generates embeddings for these text-based representations using the LLM, and stores these embeddings in a vector database, with each embedding indexed by a unique combination of node ID and relationship ID. Further, the system receives a user query specifying an information request, the user query comprising at least one intent and at least one topic. The system then decomposes the user query into a set of sub-queries, each sub-query corresponding to a distinct aspect of the information request, with each sub-query independently addressable. The system further generates embeddings for each sub-query and performs a similarity search in the vector database to retrieve relevant nodes and relationships that match the sub-query embeddings. Thereafter, the system executes a graph query using the retrieved node IDs and relationship IDs to obtain additional context from the KG. Finally, the system generates a comprehensive response to the user query using the LLM, based on the original user query, the set of sub-queries, the context retrieved from the KG, and the KG schema, thereby providing accurate and contextually rich answers to complex user queries.

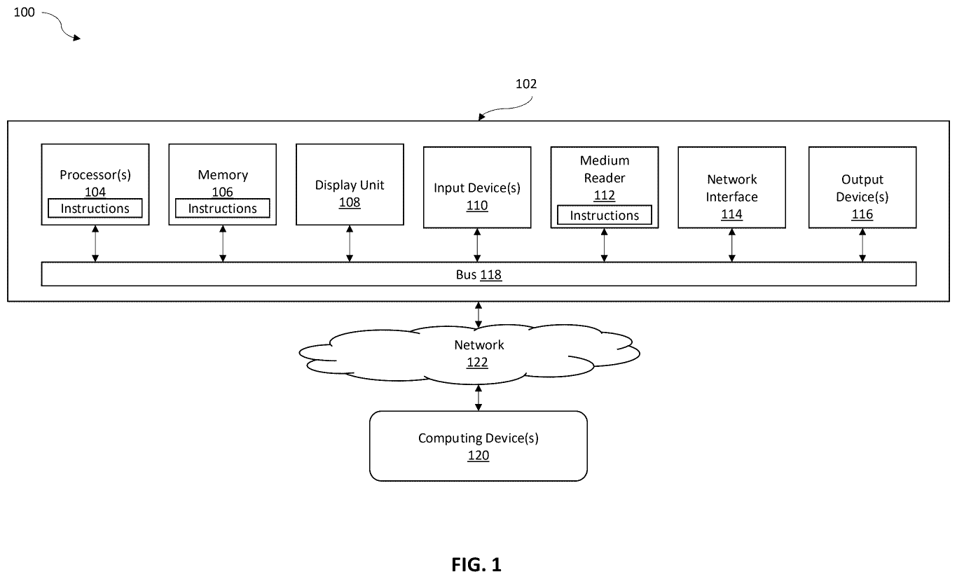

FIG. 1 is an exemplary system for use in accordance with the embodiments described herein. The system 100 is generally shown and may include a computer system 102 which is generally indicated. The term “computer system” may also be referred to as “computing device” and such phrases/terms can be used interchangeably in the specification.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks, or cloud-based environments. Even further, the instructions may be operative in such a cloud-based computing environment.

In a networked deployment, the computer system 102 may operate in the capacity of a server or as a client-user computer in a server-client user network environment, a client-user computer in a cloud-based computing environment, or as a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that can store data and executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article about manufacturing and/or machine components. Memories described herein are computer-readable mediums from which data and executable instructions can be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. As regards the present disclosure, the computer memory 106 may comprise any combination of memories or a single storage.

The computer system 102 may further include a display unit 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art will appreciate that various embodiments of the computer system 102 may include multiple input devices 110. Moreover, those skilled in the art will further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor 104, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may include but is not limited to, a speaker, an audio out, a video out, a remote-controlled output, a printer, or any combination thereof. Additionally, the term “Network interface” may also be referred to as “Communication interface” and such phrases/terms can be used interchangeably in the specification.

Each of the components of the computer system 102 may be interconnected and communicate via a bus 118 or other communication link. As shown in FIG. 1, the components may be interconnected and communicate via an internal bus. However, those skilled in the art will appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computing devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near-field communication, ultra-band, or any combination thereof. Those skilled in the art will appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

An additional computing device 120 is shown in FIG. 1 as a personal computer. However, those skilled in the art will appreciate that, in alternative embodiments of the present application, the computing device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Those skilled in the art will appreciate that the above-listed devices are merely exemplary devices and that the computing device 120 may be any additional device or apparatus commonly known and understood in the art without departing from the scope of the present application. For example, the computing device 120 may be the same or similar to the computer system 102. Furthermore, those skilled in the art will similarly understand that the device may be any combination of devices and apparatuses.

Those skilled in the art will appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor 104 described herein may be used to support a virtual processing environment.

As described herein, various embodiments provide methods and systems to execute question-and-answer tasks on a KG using an LLM.

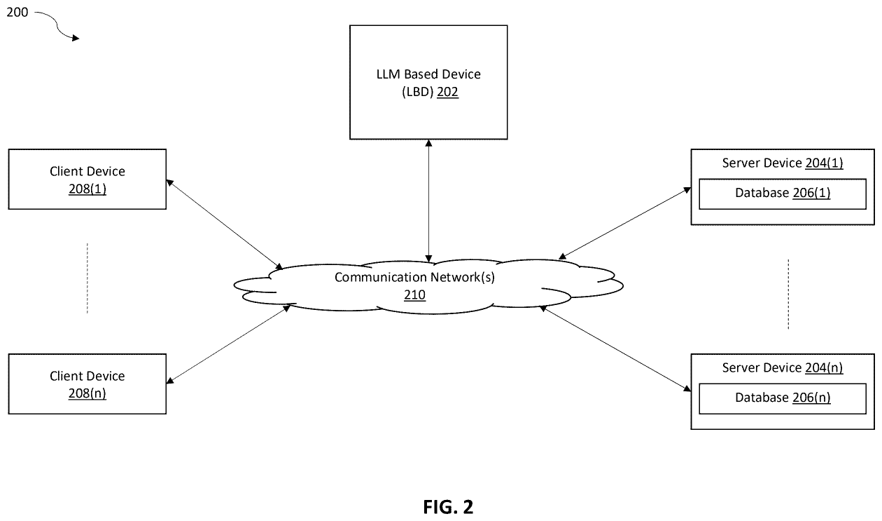

Referring to FIG. 2, a schematic of an exemplary network environment 200 to execute a question-and-answer task on a KG using an LLM is illustrated. In an exemplary embodiment, the method is executable on any networked computer platform, such as, for example, a personal computer (PC).

The method for executing a question-and-answer task on a KG using an LLM may be executed by an LLM based device (LBD) 202. The LBD 202 may be the same or similar to the computer system 102 as described with respect to FIG. 1. The LBD 202 may store one or more applications that may include executable instructions that, when executed by the LBD 202, cause the LBD 202 to perform desired actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

In a non-limiting example, the application(s) may be operative in a cloud-based computing environment. The application(s) may be executed within or as a virtual machine(s) or virtual server(s) that may be managed in a cloud-based computing environment. Also, the application(s), and even the LBD 202 itself, may be located in the virtual server(s) running in a cloud-based computing environment rather than being tied to one or more specific physical network computing devices. Also, the application(s) may be running in one or more virtual machines (VMs) executing on the LBD 202. Additionally, in one or more embodiments of this technology, virtual machine(s) running on the LBD 202 may be managed or supervised by a hypervisor.

In the network environment 200 of FIG. 2, the LBD 202 is coupled to a plurality of server devices 204(1)-204(n) that hosts a plurality of databases 206(1)-206(n), and also to a plurality of client devices 208(1)-208(n) via communication network(s) 210. A communication interface of the LBD 202, such as the network interface 114 of the computer system 102 of FIG. 1, operatively couples and communicates between the LBD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the LBD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides several advantages including methods, non-transitory computer-readable media, and LBDs that efficiently implement the method to execute a question-and-answer task on a KG using an LLM.

By way of example only, the communication network(s) 210 may include local area network(s) (LAN(s)) or wide area network(s) (WAN(s)) and can use transmission control protocol/internet protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), public switched telephone networks (PSTNs), ethernet-based packet data networks (PDNs), combinations thereof, and the like.

The LBD 202 may be a standalone device or integrated with one or more other devices or apparatuses, such as one or more of the server devices 204(1)-204(n), for example. In one particular example, the LBD 202 may include or be hosted by one of the server devices 204(1)-204(n), and other arrangements are also possible. Moreover, one or more of the devices of the LBD 202 may be in the same or a different communication network including one or more public, private, or cloud-based networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the LBD 202 via the communication network(s) 210 according to the hypertext transfer protocol (HTTP)-based and/or javascript object notation (JSON) protocol, for example, although other protocols may also be used.

The server devices 204(1)-204(n) may be hardware or software or may represent a system with multiple servers in a pool, which may include internal or external networks. The server devices 204(1)-204(n) host databases or repositories 206(1)-206(n) that are configured to store data related to KG or LLM.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud-based architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the LBD 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary embodiment, at least one client device 208 is a wireless mobile communication device, e.g., a smartphone.

The client devices 208(1)-208(n) may run interface applications, such as standard web browsers or standalone client applications, which may provide an interface to communicate with the LBD 202 via the communication network(s) 210 in order to communicate user requests and information. The client devices 208(1)-208(n) may further include, among other features, a display device, such as a display, a display unit, or a touchscreen, and/or an input device, such as a keyboard, for example.

Although the exemplary network environment 200 with the LBD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the LBD 202, the server devices 204(1)-204(n), or the client devices 208(1)-208(n), for example, may be configured to operate as virtual instances on the same physical machine. In other words, one or more of the LBD 202, the server devices 204(1)-204(n), or the client devices 208(1)-208(n) may operate on the same physical device rather than as separate devices communicating through communication network(s) 210. Additionally, there may be more or fewer LBDs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, packet data networks (PDNs), the Internet, intranets, and combinations thereof.

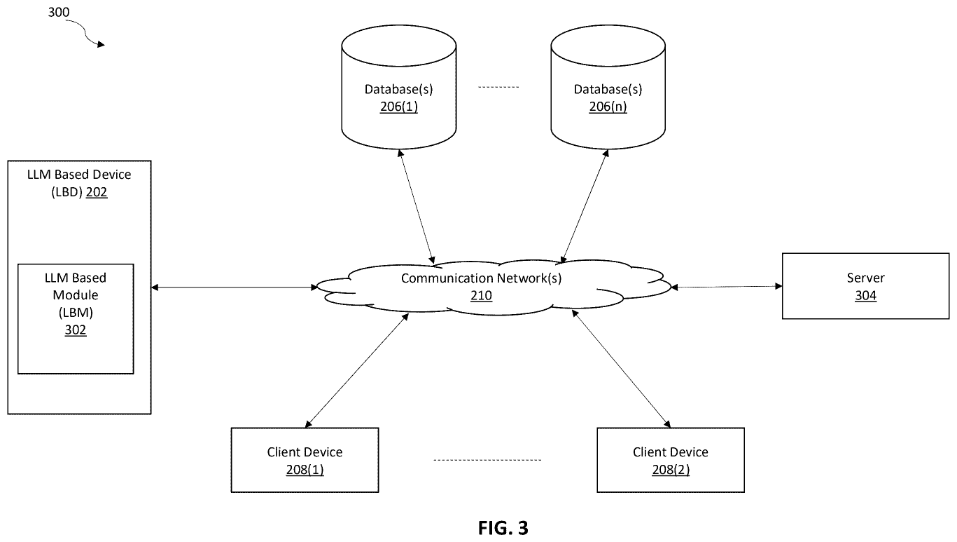

FIG. 3 illustrates a system diagram for implementing a method to execute question-and-answer tasks on a KG using an LLM, in accordance with an exemplary embodiment.

As illustrated in FIG. 3, the system 300 may include an LBD 202 within which an LLM based module (LBM) 302 is embedded, a server 304, a database(s) 206(1) . . . 206(n), a plurality of client devices 208(1) . . . 208(2), and a communication network(s) 210.

According to exemplary embodiments, the LBD 202 including the LBM 302 may be connected to the server 304, and the database(s) 206(1) . . . 206(n) via the communication network(s) 210, but the disclosure is not limited thereto. The LBD 202 may also be connected to the plurality of client devices 208(1) . . . 208(2) via the communication network 210, but the disclosure is not limited thereto. The database(s) 206(1) . . . 206(n) may include rule database.

In an embodiment, the LBD 202 is described and shown in FIG. 3 as including the LBM 302, although it may include other rules, policies, modules, databases, or applications, for example. As will be described below, the LBM 302 is configured to implement a method to execute question-and-answer tasks on a KG using an LLM.

An exemplary system 300 for implementing a mechanism to execute question-and-answer tasks on a KG using an LLM by utilizing the network environment of FIG. 2 is shown as being executed in FIG. 3. Specifically, a first client device 208(1) and a second client device 208(2) are illustrated as being in communication with the LBD 202. In this regard, the first client device 208(1) and the second client device 208(2) may be “clients” of the LBD 202 and are described herein as such. Nevertheless, it is to be known and understood that the first client device 208(1) and/or the second client device 208(2) need not necessarily be “clients” of the LBD 202, or any entity described in association therewith herein. Any additional or alternative relationship may exist between either or both of the first client device 208(1) and the second client device 208(2) and the LBD 202, or no relationship may exist.

Further, the LBD 202 is illustrated as being able to access one or more databases 206(1) . . . 206(n). The LBM 302 may be configured to access these repositories/databases for implementing a method to execute question-and-answer tasks on a KG using an LLM. In some embodiments, the server 304 may be the same or equivalent to the server device 204 as illustrated in FIG. 2.

The first client device 208(1) may be, for example, a smartphone. The first client device 208(1) may be any additional device described herein. The second client device 208(2) may be, for example, a personal computer (PC). The second client device 208(2) may also be any additional device described herein.

The process may be executed via the communication network(s) 210, which may comprise plural networks as described above. For example, in an exemplary embodiment, either or both the first client device 208(1) and the second client device 208(2) may communicate with the LBD 202 via broadband or cellular communication. These embodiments are merely exemplary and are not limiting or exhaustive.

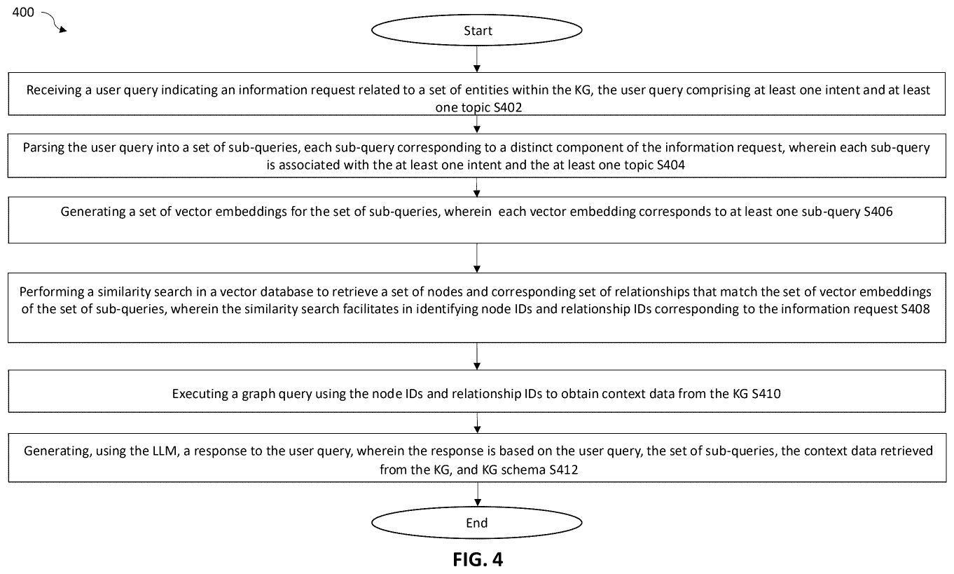

Referring to FIG. 4, an exemplary method 400 is shown to execute question-and-answer tasks on a KG using an LLM, in accordance with an exemplary implementation.

As shown in FIG. 4, the method 400 begins following a need for executing question-and-answer tasks on a KG using an LLM. The method 400 is implemented by at least one processor 104.

At step S402, the method 400 includes receiving, by the at least one processor 104, a user query indicating an information request related to a set of entities within the KG, the user query comprising at least one intent and at least one topic. In an exemplary embodiment, the user query may refer to a natural language input or a structured request submitted by a user to retrieve specific information from the KG. For example, the user query could be, “List all tech companies in San Francisco with revenue over 1 billion USD,” or “Show companies in the healthcare sector excluding those with revenue under 50 million USD.” Each of these queries expresses a distinct request for information related to entities within the KG.

In an exemplary embodiment, the intent of the user query may correspond to a component that defines the purpose or desired outcome of the user query. The intent may specify whether the user is looking to include the set of entities, exclude the set of entities, or filter results based on given criteria. In an exemplary implementation, in the query “Show all companies in New York with more than 500 employees,” the intent is to include the set of entities that meet the specified conditions. Alternatively, in the query “Exclude companies headquartered outside the United States,” the intent is exclusionary, aiming to filter out the set of entities that do not meet the location criterion.

In an exemplary embodiment, the topic in the user query may define the subject matter or the attribute associated with the set of entities within the KG. The topic may correspond to specific characteristics or fields within the KG, such as location, industry, revenue, or employee count, which guides the system's focus to relevant parts of the KG. In an exemplary implementation, in the query “Find pharmaceutical companies with revenue above 100 million USD,” the topics are “industry” (i.e., pharmaceutical) and “revenue” (i.e., above 100 million USD). The topic helps narrow down the search within the KG, allowing the system to efficiently locate and retrieve the set of entities that match the user's information requirement.

The method 400 further includes converting, by the at least one processor, node-edge-node relationships in the knowledge graph (KG) into a set of text-based representations, wherein each text-based representation describes a relationship between two nodes in the KG. In an exemplary embodiment, each “node-edge-node” relationship in the KG represents a connection between two entities, or nodes, linked by a specific relationship, or edge. In an exemplary implementation, in a KG that stores corporate information, a relationship might link the node representing “Company A” to “Company B” via an edge labeled “acquired.” Converting this relationship into a text-based representation could result in the phrase “Company A acquired Company B,” making the structured relationship interpretable as text. Therefore, each node-relation-node pair is transformed into a standard text format, such as “Node A has an X relationship with Node B.” This text is then converted into embeddings using a LLM. These embeddings are stored in a vector database, with a different index for each relationship.

In this way, once the text-based representations are created, the method 400 includes converting them into the set of vector embeddings. By generating an embedding for each text-based relationship, the system translates the information into a format that allows for similarity-based retrieval. In an exemplary implementation, the “Company A acquired Company B” text will be transformed into a vector embedding, capturing the nature of the acquisition relationship between the two companies. The set of vector embedding not only preserves the entity-relationship-entity structure but may also encode contextual meaning, enabling the system to find similar relationships during searches.

At step S404, the method includes parsing, by the at least one processor 104, the user query into a set of sub-queries, each sub-query corresponding to a distinct component of the information request, wherein each sub-query is associated with the at least one intent and the at least one topic. By breaking down a query into a set of sub-queries, the system may isolate and address each part of the user query separately, enabling more precise and efficient retrieval of information from the KG.

In an exemplary embodiment, each sub-query generated may correspond to a unique component of the user query. In an exemplary implementation, a user query like “Show technology companies in New York with revenue over 1 billion USD and fewer than 500 employees.” This query includes multiple criteria related to industry (“technology”), location (“New York”), revenue (“over 1 billion USD”), and employee count (“fewer than 500”). The processor 104 would parse this query into four sub-queries: one for each distinct condition. Each sub-query is associated with an intent, such as including or excluding certain entities, and a topic, which specifies the attribute or aspect relevant to that sub-query (e.g., “industry type,” “location,” “revenue,” or “employee count”).

In an exemplary embodiment, the intent and topic for each sub-query may provide a framework for targeted information retrieval within the KG. In an exemplary implementation, the sub-query associated with “technology companies” would have an intent to include entities in the technology sector and a topic of “industry.” Similarly, the sub-query focused on “New York” would aim to include entities located in that region, with the topic being “location”.

Parsing the queries into sub-queries may be particularly useful for handling complex or multi-dimensional requests. In an exemplary implementation, consider the query “Find European renewable energy companies with fewer than 200 employees and more than 50 million USD in revenue.” Here, the processor may generate four sub-queries: one for “location” (Europe), one for “industry” (renewable energy), one for “employee count” (fewer than 200), and one for “revenue” (above 50 million USD). Each sub-query may be mapped to a specific intent and topic, allowing the system to conduct precise searches in the KG for nodes and relationships that satisfy each criterion individually. By addressing each component separately, the system may construct a more accurate and relevant response that meets all aspects of the user's information request.

The parsing of the user query includes mapping, by the at least one processor 104, each intent to a corresponding relationship type within the KG; and mapping each topic to a node type within the KG. In an exemplary embodiment, mapping each intent may include aligning the action or purpose specified in the query-such as inclusion, exclusion, or interaction, with a corresponding relationship type in the KG. Similarly, topic mapping may connect the subject matter or attributes specified in the user query with relevant node types in the KG. The systematic mapping helps the processor 104 to accurately interpret the query within the KG framework, preparing it for precise retrieval of relevant entities and relationships.

In an exemplary embodiment, for intent mapping, each intent specified in the user query may be matched to a relationship type that reflects the desired interaction between nodes. For instance, if the user query is “Show companies in New York that have invested in healthcare startups”, then the intent here may be described as to identify an investment relationship. The processor 104 may map this intent to the relationship type “invested in” within the KG, such that the search focuses on connections between New York companies and healthcare startups specifically tied by an investment link. By associating intent with relationship types, the processor may target only those connections in the KG that align with the user's specific request, minimizing irrelevant data and enhancing retrieval precision.

In an exemplary embodiment, for topic mapping, each topic in the user query may be matched to a corresponding node type that represents the subject matter in the KG. The topics “companies in New York” and “healthcare startups” may be mapped to node types like “Company” and “Startup” within the KG. For example, the node type “Company” may include entities classified as businesses, while the node type “Startup” would focus on entities designated as young or early-stage companies. This topic-to-node mapping may guide the processor in identifying and retrieving only those nodes that match the user's subject focus, further refining the search parameters within the KG.

At step S406, the method includes generating, by the at least one processor 104, a set of vector embeddings for the set of sub-queries, wherein each vector embedding corresponds to at least one sub-query. The set of vector embeddings may correspond to mathematical representations of textual data, where the data such as words, phrases, or queries are transformed into numerical vectors. Each sub-query may then be converted into a unique vector embedding, thereby capturing a semantic meaning of the sub-query in a format that enables efficient comparison and matching within the KG.

In an exemplary embodiment, the vector embedding process may enable the system to represent each sub-query in a high-dimensional space, where semantically similar concepts are positioned close to one another. In an exemplary implementation, consider a user query that has been broken down into sub-queries such as “technology companies,” “New York,” and “revenue over 1 billion USD.” For each of these sub-queries, the processor generates a distinct vector embedding that represents the semantic content of the sub-query. The vector for “technology companies” will capture nuances associated with the technology industry, the vector for “New York” would represent geographical relevance, and the vector for “revenue over 1 billion USD” will reflect financial metrics. Each of these embeddings is generated such that the system can match these sub-query requirements to nodes and relationships within the KG.

In an exemplary implementation, if the query is “Find renewable energy companies in Europe with over 200 employees,” the sub-query embeddings would reflect key dimensions such as “industry” (renewable energy), “location” (Europe), and “employee count” (over 200). In the vector space, these embeddings may be positioned near nodes in the KG that also represent renewable energy companies located in Europe with large employee counts. This proximity in vector space may allow the system to perform similarity searches that prioritize relevant matches, improving the relevance of the information retrieved.

In an exemplary embodiment, the process of generating the set of vector embeddings may also help standardize different sub-queries into a common format that can be consistently compared across various KG nodes and relationships. In an exemplary implementation, a user might input a query asking for “tech firms in Silicon Valley” or “technology companies in the Bay Area.” Despite slight differences in wording, vector embeddings may capture the underlying meaning, positioning both “Silicon Valley” and “Bay Area” as geographically relevant and semantically similar within the context of technology. As a result, the embedding may facilitate more nuanced matching, allowing the system to account for different ways users may phrase similar requests.

After generating the set of vector embeddings, the method 400 further includes storing, by the at least one processor 104, the set of vector embeddings in a vector database. In an exemplary embodiment, each embedding may be indexed according to a combination of node ID and relationship ID for efficient identification and retrieval. Indexing based on node IDs and relationship IDs may enable to map each embedding directly to the corresponding entities and relationships in the KG. In an exemplary implementation, if “Company A” has a node ID of 101 and “acquisition” has a relationship ID of 205, the combined index (101, 205) serves as a unique identifier for the embedding “Company A acquired Company B”. It will be appreciated by the person skilled in the art that the indexing allows the system to locate and retrieve the set of vector embeddings quickly when a relevant query is processed.

In an exemplary embodiment, each relationship type may be stored in a separate index within the vector database, thereby optimizing retrieval. By segmenting the vector database according to relationship types, the method 400 may allow the system to quickly narrow down searches based on the type of relationship specified in a user query. In an exemplary implementation, if a user query focuses on “partnerships,” the system may limit the similarity search to embeddings stored in the “partnership” index, avoiding unrelated embeddings, and improving search efficiency. The organization by relationship type may be useful for complex KGs with diverse relationship types, such as “acquisition,” “partnership,” “investment,” or “ownership.”

It will be appreciated by the person skilled in the art that by converting node-edge-node relationships into text-based representations, transforming them into vector embeddings, and storing them in a structured vector database may equip the system to manage natural language queries with high efficiency. Further, by organizing embeddings based on node and relationship IDs and creating separate indices for each relationship type, the system may be able to perform rapid similarity searches that yield relevant results aligned with the user's query intent.

At step S408, the method includes performing, by the at least one processor 104, a similarity search in the vector database to retrieve a set of nodes and corresponding set of relationships that match the set of vector embeddings of the set of sub-queries, wherein the similarity search facilitates in identifying node IDs and relationship IDs corresponding to the information request. In an exemplary embodiment, the similarity search may include comparing the set of vector embeddings of each sub-query against the set of vector embeddings stored in the vector database, which represents nodes and relationships within the KG. By measuring the “distance” between vectors, the system may identify nodes and relationships that are semantically aligned with each sub-query, allowing it to retrieve the most relevant information for the user's request.

In an exemplary embodiment, the similarity search may facilitate in matching the intent and topic embedded in the set of sub-queries to the structured data within the KG. In an exemplary implementation, if a user query has been broken down into the set of sub-queries such as “technology companies,” “located in San Francisco,” and “with revenue over 1 billion USD,” each sub-query will have an associated vector embedding. During similarity search, the processor scans the vector database to find nodes whose embeddings are closest to the vector for “technology companies,” focusing on entities categorized under the technology sector. Simultaneously, it will search for nodes and relationships that match vectors for “San Francisco” and “revenue over 1 billion USD,” effectively narrowing down to entities and connections that satisfy all parts of the user query.

In an exemplary embodiment, the similarity search may utilize the set of vector embeddings to find data points that are closest in meaning to the sub-queries, regardless of variations in phrasing or structure. In an exemplary implementation, if the user's query was “Find large healthcare firms in New York,” and the sub-query embeddings include “healthcare sector” and “location: New York,” the similarity search will prioritize KG nodes associated with large healthcare companies in that area. By examining vector proximity, the processor 104 may efficiently retrieve node IDs and relationship IDs that correspond to the set of entities meeting these conditions, even if they are not described exactly as in the original query.

In an exemplary embodiment, the similarity search process may enable the retrieval of complex relationships that provide deeper insights into the query. In an exemplary implementation, if the query includes “companies with partnerships in renewable energy,” the similarity search will not only retrieve nodes related to renewable energy companies but also identify relevant relationship IDs that indicate partnerships.

At step S410, the method includes executing, by the at least one processor 104, a graph query using the node IDs and relationship IDs to obtain context data from the KG. In an exemplary embodiment, the node IDs and relationship IDs represent the set of entities and their corresponding set of connections in the KG and act as indicators for the processor 104 to locate the context data.

In an exemplary embodiment, the execution of a graph query may enable the processor 104 to access deeper layers of relational information within the KG, enhancing the richness of the response. In an exemplary implementation, if the user query was “List tech companies in San Francisco with partnerships in renewable energy,” the previous steps may have identified node IDs for tech companies based in San Francisco and relationship IDs for partnerships within renewable energy. Thereafter, the processor 104 may retrieve context data associated with the set of entities and the corresponding set of relationships, such as the names of partner companies, the type of partnership (e.g., strategic, investment), and other attributes that describe the nature and scope of these collaborations.

In an exemplary embodiment, by using both node IDs and relationship IDs the processor 104 may obtain a response that reflects the relational complexity of the user's query. In an exemplary implementation, for a query “Find pharmaceutical companies in New York connected to research institutions via joint research projects”, the processor 104 can use the node ID for “pharmaceutical companies in New York” and the relationship ID for “joint research projects” to obtain the context data on specific research institutions, the projects they share with each pharmaceutical company, and other details that contribute to the overall relationship.

At step S412, the method includes generating, by the at least one processor 104 using the LLM, a response to the user query, wherein the response is based on the user query, the set of sub-queries, the context data retrieved from the KG, and KG schema.

In an exemplary embodiment, the method further includes inputting, by the at least one processor 104, the context data and the user query into the LLM to generate the response to the user query. By feeding both the user query and context data into the LLM, the processor 104 may enable the LLM to generate a response that is comprehensive, accurate, and contextually enriched. The context data may provide essential background and details that the LLM uses to create a response that directly addresses each aspect of the query. In an exemplary implementation, if the user query was “List healthcare companies in California with revenue over 500 million USD,” the context data may include specific nodes for healthcare companies located in California and their revenue figures.

In an exemplary embodiment, the combination of the user query and context data enables the LLM to generate the response specifically based on the user's intent. In an exemplary implementation, a query like “Show partnerships between renewable energy companies in Europe” will yield context data that includes relevant companies, geographical attributes, and partnership relationships. When this data is input into the LLM, the model understands both the focus (renewable energy partnerships) and the geographical constraint (Europe). Consequently, the LLM may generate a structured response listing each relevant partnership and the details of the entities involved, giving the user a clear, concise answer that satisfies their original request.

In an exemplary embodiment, the LLM constructs a coherent and comprehensive response by synthesizing information from multiple components: the original user query, the parsed sub-queries, the specific context data retrieved from the knowledge graph (KG), and the KG schema, which provides structure and definition for the entities and relationships in the graph.

In an exemplary implementation, if a user has asked, “List the technology companies in California with revenue over 500 million USD that have recently acquired other companies,” the LLM will use the context data retrieved from the KG to identify relevant companies, financial data, and acquisition details.

In an exemplary embodiment, the use of the set of sub-queries in generating the response may enable each element of the user's request to be addressed individually, which is then synthesized by the LLM into a complete response. In an exemplary implementation, a query like “Find renewable energy companies in Europe with more than 200 employees and partnerships in research projects” will have sub-queries focusing on “industry” (renewable energy), “location” (Europe), “employee count” (more than 200), and “partnerships in research.” The LLM may process these sub-queries along with the retrieved context to confirm that each condition is met, and that the response accurately includes companies that align with all criteria.

In an exemplary embodiment, the KG schema contains information about entity types, relationship types, and data hierarchies, which the LLM uses to format and arrange the response. In an exemplary implementation, if the KG schema defines specific types of partnerships (e.g., “strategic alliance” or “joint venture”), the LLM will present these types as defined by the schema, enhancing the accuracy and relevance of the information.

In an exemplary embodiment, the integration of the KG schema may also enable the LLM to manage complex responses involving hierarchical or nested data. In an exemplary implementation, if the user query is “Show the hierarchy of suppliers for a pharmaceutical company, including tier-one and tier-two suppliers in North America,” the KG schema informs the LLM about the hierarchy and relevant classifications of suppliers. The LLM then structures the response to reflect this hierarchy, differentiating between tier-one and tier-two suppliers, and organizes the results according to the geographic focus on North America.

The method 400 further includes rendering, by the at least one processor 104 using a display unit, the response generated by the LLM, wherein the response comprises the set of entities and corresponding set of relationships in the knowledge graph (KG) that satisfy the information request. In an exemplary embodiment, the output generated by the large language model (LLM) is rendered on a user-facing display, such as a monitor, mobile screen, or dashboard. The response displayed may include not only the relevant entities that match the user query, but also the associated relationships within the KG that connect these entities. By visualizing both entities and their relationships, the user may gain a more complete understanding of the information retrieved from the KG and how it directly addresses the query.

In an exemplary implementation, if a user query requests “Show technology companies in California with partnerships in renewable energy”, the response rendered on the display will include a list of entities representing California-based technology companies that have connections in the renewable energy sector. Alongside each entity, the display may show the “partnership” relationships, linking each technology company to relevant renewable energy partners. This structured response format may allow the user to see both the entities of interest and the specific relationships that satisfy the conditions of the query, making the information intuitive and actionable.

Thereafter, the method 400 terminates.

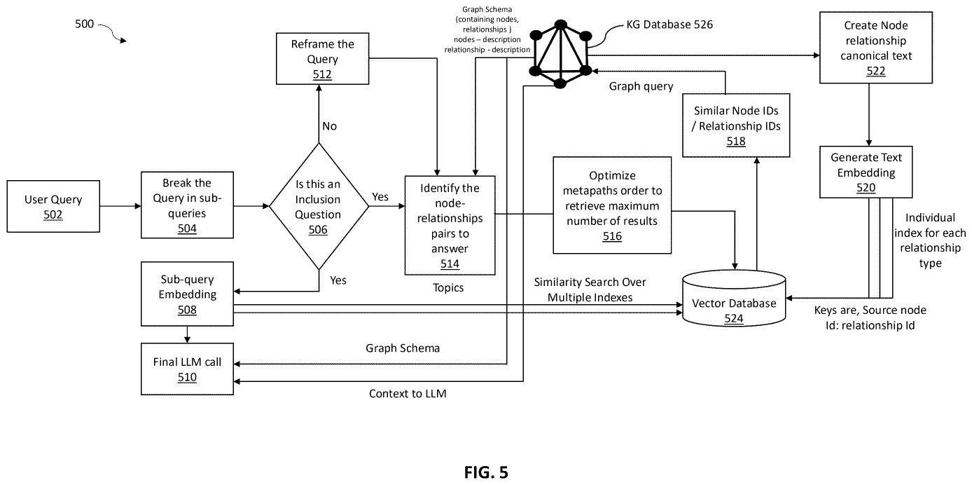

FIG. 5 illustrates an exemplary process flow 500 of a system for executing a question-and-answer task on a KG using an LLM, in accordance with an embodiment of the present disclosure.

At 502, the system receives a user query. The user query may be in a natural language and may include specific criteria or questions related to entities or relationships within the KG. For example, the user query may be “Find healthcare companies in California with revenue over 500 million USD.”

At 504, upon receiving the user query, the system may break down the query into sub-queries. This parsing process may involve identifying the main topics and intents within the query, such as “healthcare companies,” “location: California,” and “revenue over 500 million USD.” Each of these sub-queries may represent a specific aspect of the user's request, allowing the system to address each part separately in the KG.

At 506, after breaking down the query, the system may evaluate the type of intent within the query by determining whether it is an inclusion question. An inclusion question implies that the user wants to include entities that meet specific criteria. For instance, if the query specifies “companies with revenue over 500 million USD,” it is an inclusion question as it seeks entities that satisfy this condition. If the system determines that the query is an inclusion question, it may follow a “Yes” branch; otherwise, it may take an alternative route to handle exclusion or other complex logic.

At 508, each sub-query may then be converted into a vector embedding, capturing the semantic meaning of the sub-query in a high-dimensional vector format. This embedding may allow the system to perform similarity searches against stored embeddings in the KG. For instance, sub-queries such as “California” and “revenue over 500 million USD” would each have a unique vector embedding representing their specific attributes.

At 510, the information retrieved from the KG may be used as context for the LLM to provide answers to queries.

At 512, if the original query cannot be directly answered with a straightforward inclusion or exclusion approach, the system may reframe the query to better align with the KG's structure. This reframing step may help optimize the query for efficient information retrieval.

At 514, the system may identify the node-relationship pairs required to answer the query. This may involve mapping each sub-query to corresponding nodes (entities) and relationships in the KG. For example, a sub-query about “partnerships in renewable energy” will identify node types related to companies and relationship types like “has_partnership.”

At 516, the system may then optimize the order of metapaths to maximize retrieval efficiency. A metapath may represent a specific sequence of relationships connecting different types of nodes within the KG.

At 518, after optimizing the metapath order, the system may perform a similarity search in the KG, retrieving similar node IDs and relationship IDs based on the vector embeddings of the sub-queries. For example, if the query focuses on “biotech companies in New York with partnerships in AI research,” the system will identify and retrieve relevant nodes representing biotech companies in New York and relationships indicating AI partnerships.

At 520, to further facilitate similarity-based searches, the system may generate text embeddings for each relevant node-edge-node relationship in the KG. These text-based representations may describe connections between entities, such as “Company A has invested in Company B,” and are transformed into vector embeddings for more efficient search and retrieval.

At 522, the system may create canonical text representations for each node-relationship pairing. For example, it may store a relationship as “Company A is located in California and has revenue exceeding 500 million USD.” This canonical text may provide a consistent format for interpreting and displaying relationships within the KG.

At 524, all vector embeddings generated from the sub-queries and canonical texts may be stored in a vector database. This vector database may organize embeddings for nodes and relationships based on semantic similarity, enabling efficient similarity searches. For example, embeddings related to companies, locations, and financial metrics are indexed in such a way that facilitates rapid access during information retrieval.

At 526, the KG database may store all the entities and relationships in the structured form of a graph, with nodes and edges representing different entities and their connections. The system may reference this KG database to retrieve detailed information about each entity or relationship that aligns with the user query, using the node IDs and relationship IDs identified in previous steps.

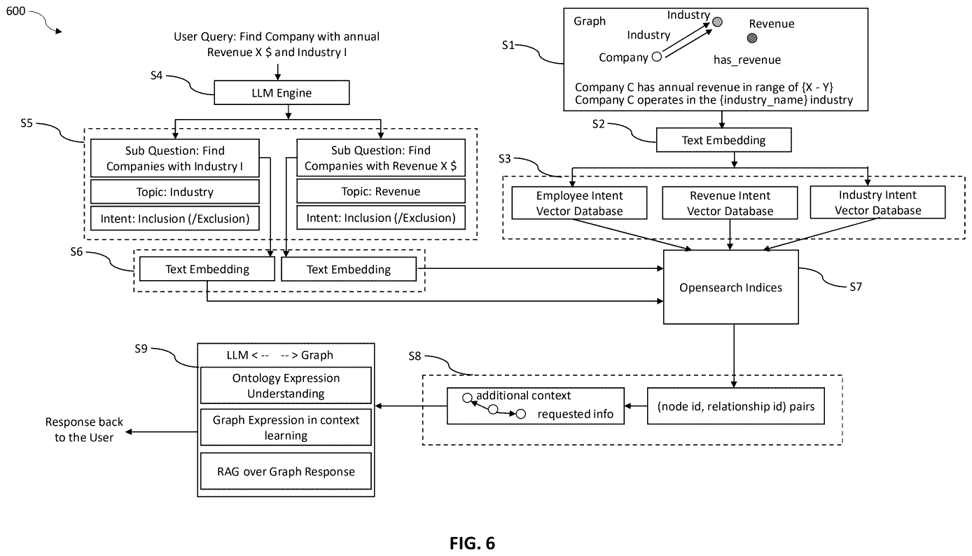

FIG. 6 illustrates an exemplary flow diagram for executing a question-and-answer task on a KG using an LLM, in accordance with an exemplary embodiment of the present disclosure.

The process 600 begins when a user query is received, specifically asking, “Find companies with annual revenue of X $ and industry I.”

At step S1, the system recognizes the two key elements within this query: a revenue criterion (“annual revenue of X $”) and an industry criterion (“industry I”). These elements represent specific constraints the user wishes to apply in their search for relevant entities within the knowledge graph (KG). Additionally, the query specifies that the user is interested in retrieving information specifically about companies.

At step S2, the process involves generating text embeddings for each key component of the user query. Text embeddings are vectorized representations of textual data, which allow the system to capture the semantic meaning of each query component. For example, the criteria “annual revenue of X $” and “industry I” are each transformed into embeddings that encapsulate their meaning.

Following embedding generation, at step S3, these embeddings are stored in specific vector databases based on the intent associated with each sub-query. The system organizes these embeddings within databases dedicated to different aspects of the KG, such as an Employee Intent Vector Database, a Revenue Intent Vector Database, and an Industry Intent Vector Database. For this particular query, the embeddings related to revenue would be stored in the Revenue Intent Vector Database, while those related to industry would be stored in the Industry Intent Vector Database.

At step S4, the LLM Engine is engaged to interpret and process the overall user query. The LLM engine helps analyze and decompose the query further, enabling the system to interpret the query's intent accurately.

Based on the insights from the LLM engine, step S5 involves creating two distinct sub-questions that align with the components of the user query. The first sub-question is “Find companies with Industry I,” with the Topic identified as “Industry” and the Intent marked as “Inclusion” (or Exclusion, if specified by the user). The second sub-question is “Find companies with Revenue X $,” with the Topic identified as “Revenue” and the Intent also marked as “Inclusion” (or Exclusion).

At step S6, the process includes generating text embeddings (such as the set of vector embeddings) for each sub-question. The text embeddings capture the semantic content of each sub-query and allow the system to perform similarity-based searches. Each sub-question, such as “Industry I” and “Revenue X $,” is represented as a vector that enables the system to retrieve nodes and relationships within the KG that match these criteria.

Using the generated text embeddings, the system then performs a similarity search at step S7 by querying OpenSearch indices. These indices are designed for efficient similarity search and contain precomputed embeddings for various nodes and relationships within the KG. By comparing the sub-query embeddings against these indices, the system can quickly identify nodes and relationships that are most relevant to the user's criteria, such as companies with the specified revenue and industry attributes. At step S8, the system retrieves additional context and forms (node ID, relationship ID) pairs based on the initial search results. This additional context includes related entities and connections within the KG that provide further insights into each retrieved node. For example, if the query involves “companies with revenue X $ in industry I,” the system might retrieve related information such as each company's location, partnerships, or historical data on revenue and industry. By adding this context, the system can generate a more comprehensive response, enriched with relevant details beyond the primary query criteria.

Moving to step S9, the system leverages a two-way interaction between the LLM and the KG. This interaction includes several layers of understanding and processing: Ontology Expression Understanding, Graph Expression in Context Learning, and Retrieval-Augmented Generation (RAG) over Graph Response. In the Ontology Expression Understanding phase, the LLM interprets the structure and relationships within the KG, allowing it to recognize how entities are organized and interconnected. In the Graph Expression in Context Learning phase, the LLM utilizes the contextual information gathered from the KG to understand how various entities relate to each other based on the query's requirements.

After the LLM has generated the response, the system sends the final answer back to the user. This response includes details that directly address the user's query, such as a list of companies that match the specified revenue and industry criteria. Additionally, the response may include enriched context if relevant, providing a comprehensive answer that not only meets but also enhances the user's information needs.

The present disclosure provides a system and method for executing question-and-answer tasks on a KG using a large language model (LLM), enhancing information retrieval accuracy and response depth. By decomposing complex user queries into sub-queries, generating embeddings, and leveraging intent-based vector databases, the system performs efficient similarity searches within the KG to retrieve relevant entities and context. This approach enables dynamic query handling and schema independence, allowing the system to adapt to changing KG structures without manual reconfiguration. Additionally, the modular design and retrieval-augmented generation (RAG) framework enable rich, contextually accurate answers while minimizing redundant processing. The system's scalability, customizable configuration, and efficient embedding storage make it suitable for diverse applications, delivering operational efficiency and reducing the complexity of managing KG data in Q&A tasks.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor 104 or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tape, or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to an aspect of the present disclosure, a non-transitory computer-readable storage medium storing instructions to provide an adaptive application programming interface (API) framework is disclosed. The instructions include executable code which, when executed by a processor 104, may cause the processor 104 to receive a user query indicating an information request related to a set of entities within the KG, the user query comprising at least one intent and at least one topic; parse the user query into a set of sub-queries, each sub-query corresponding to a distinct component of the information request, wherein each sub-query is associated with the at least one intent and the at least one topic; generate a set of vector embeddings for the set of sub-queries, wherein each vector embedding corresponds to at least one sub-query; perform a similarity search in a vector database to retrieve a set of nodes and corresponding set of relationships that match the set of vector embeddings of the set of sub-queries, wherein the similarity search facilitates in identifying node IDs and relationship IDs corresponding to the information request; execute a graph query using the node IDs and relationship IDs to obtain context data from the KG; and generate, using the LLM, a response to the user query, wherein the response is based on the user query, the set of sub-queries, the context data retrieved from the KG, and KG schema.

Although the present specification describes components and functions that may be implemented in particular embodiments with reference to particular standards and protocols, the disclosure is not limited to such standards and protocols. Such standards are periodically superseded by faster or more efficient equivalents having the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

1. A method for executing a question-and-answer task on a knowledge graph (KG) using a large language model (LLM), the method being implemented by at least one processor, the method comprising:
receiving, by the at least one processor, a user query indicating an information request related to a set of entities within the KG, the user query comprising at least one intent and at least one topic, and the user query being a natural language input submitted by a first user;
parsing, by the at least one processor, the user query into a set of sub-queries, each sub-query corresponding to a distinct component of the information request, wherein each sub-query is associated with the at least one intent and the at least one topic;
generating, by the at least one processor, a set of vector embeddings for the set of sub-queries, wherein each respective vector embedding corresponds to at least one respective sub-query;
performing, by the at least one processor, a similarity search in a vector database to retrieve a set of nodes and a corresponding set of relationships that matches the set of vector embeddings of the set of sub-queries, wherein the similarity search facilitates in identifying node identifiers (IDs) and relationship IDs corresponding to the information request;
executing, by the at least one processor, a graph query using the node IDs and relationship IDs to obtain context data from the KG; and
generating, by the at least one processor using the LLM, a response to the user query, wherein the response is based on the user query, the set of sub-queries, the context data retrieved from the KG, and KG schema,
wherein the method further comprises:
converting, by the at least one processor, node-edge-node relationships in the KG into a set of text-based representations, wherein each respective text-based representation describes a respective relationship between two respective nodes in the KG;
transforming the set of text-based representations into the set of vector embeddings; and
storing, by the at least one processor, the set of vector embeddings in the vector database, each respective vector embedding being indexed according to a combination of a corresponding node ID and a corresponding relationship ID, and with each respective relationship having a corresponding relationship type that is stored in a separate respective index within the vector database.

2. The method as claimed in claim 1, further comprising:
inputting, by the at least one processor, the context data and the user query into the LLM to generate the response to the user query.

3. (canceled)

4. The method of claim 1, wherein the storing of the set of vector embeddings in the vector database comprises creating a separate respective index for each respective type of relationship in the KG.

5. The method as claimed in claim 1, further comprising:
rendering, by the at least one processor using a display, the response generated by the LLM, wherein the response comprises the set of entities and the corresponding set of relationships in the KG that satisfy the information request.

6. The method of claim 1, wherein the at least one intent of each sub-query indicates whether the sub-query specifies an inclusion criterion to include the set of entities based on a specific condition, or an exclusion criterion to omit the set of entities based on the specific condition.

7. The method of claim 1, wherein the parsing of the user query comprises:
mapping, by the at least one processor, each respective intent to a corresponding relationship type within the KG; and
mapping, by the at least one processor, each respective topic to a corresponding node type within the KG.

8. A computing device configured to execute a question-and-answer task on a knowledge graph (KG) using a large language model (LLM), the computing device comprising:
at least one processor;
a memory; and
a communication interface coupled to each of the at least one processor and the memory,
wherein the at least one processor is configured to:
receive a user query indicating an information request related to a set of entities within the KG, the user query comprising at least one intent and at least one topic, and the user query being a natural language input submitted by a first user;
parse the user query into a set of sub-queries, each sub-query corresponding to a distinct component of the information request, wherein each sub-query is associated with the at least one intent and the at least one topic;
generate a set of vector embeddings for the set of sub-queries, wherein each respective vector embedding corresponds to at least one respective sub-query;
perform a similarity search in a vector database to retrieve a set of nodes and a corresponding set of relationships that matches the set of vector embeddings of the set of sub-queries, wherein the similarity search facilitates in identifying node identifiers (IDs) and relationship IDs corresponding to the information request;
execute a graph query using the node IDs and relationship IDs to obtain context data from the KG; and
generate, using the LLM, a response to the user query, wherein the response is based on the user query, the set of sub-queries, the context data retrieved from the KG, and KG schema.
wherein the at least one processor is further configured to:
convert node-edge-node relationships in the KG into a set of text-based representations, wherein each respective text-based representation describes a respective relationship between two respective nodes in the KG;
transform the set of text-based representations into the set of vector embeddings; and
store the set of vector embeddings in the vector database, each respective vector embedding being indexed according to a combination of a corresponding node ID and a corresponding relationship ID, and with each respective relationship having a corresponding relationship type that is stored in a separate respective index within the vector database.

9. The computing device as claimed in claim 8, wherein the at least one processor is further configured to input the context data and the user query into the LLM to generate the response to the user query.

10. (canceled)

11. The computing device as claimed in claim 8, wherein the at least one processor is further configured to store the set of vector embeddings in the vector database by creating a separate respective index for each respective type of relationship in the KG.

12. The computing device as claimed in claim 8, wherein the at least one processor is further configured to render, using a display, the response generated by the LLM, wherein the response comprises the set of entities and the corresponding set of relationships in the KG that satisfy the information request.

13. The computing device as claimed in claim 8, wherein the at least one intent of each sub-query indicates whether the sub-query specifies an inclusion criterion to include the set of entities based on a specific condition, or an exclusion criterion to omit the set of entities based on the specific condition.

14. The computing device as claimed in claim 8, wherein to parse the user query, the at least one processor is further configured to:
map each respective intent to a corresponding relationship type within the KG; and
map each respective topic to a corresponding node type within the KG.
